(19) United States
(12) Patent Application Publication
(10) Pub. No.: US 2022/0284451 A1
(43) Pub. Date: Sep. 8, 2022

(54) METHODS AND APPARATUS FOR ELECTRONIC MAPPING OF CUSTOMER DATA

(71) Applicant: Walmart Apollo, LLC, Bentonville, AR (US)

(72) Inventors: Dong Xu, San Jose, CA (US); Peng Yang, San Jose, CA (US)

(21) Appl. No.: 17/192,806

(22) Filed: Mar. 4, 2021

(51) Int. Cl. G06Q 30/02; G06F 16/215; G06F 16/21; G06F 16/2458

(52) U.S. Cl. CPC G06Q 30/0201; G06F 16/215; G06F 16/219; G06F 16/2477

(57) ABSTRACT

This application relates to apparatus and methods for mapping identifiers to customer data over temporal intervals. Various applications may then operate on the mapped customer data to generate output data, such as digital item advertisements. In some examples, a computing device receives a first identifier of a first type, and a plurality of second identifiers of a second type. The computing device obtains customer data, such as sales and browsing data, associated with each of the second identifiers, and generates a confidence score for each of the second identifiers based on the corresponding customer data. Further, the computing device generates mapping data that maps the first identifier to one of the plurality of second identifiers based on the confidence scores. In some examples, the computing device determines the mapping data based on temporal intervals associated with the first identifier and each of the plurality of second identifiers.

### TECHNICAL FIELD

The disclosure relates generally to e-commerce systems and, more specifically, to e-commerce systems that electronically associate customer data to customers.

### BACKGROUND

Some retailers, such as online retailers, provide websites that allow customers to view and purchase items. For example, the website may include a search bar that allows a customer to enter a search query, such as one or more words, that the website uses to search for items. In response to the provided search query, the website may display search results determined by a search algorithm, such as a machine learning model, implemented by the website. The search results may identify items that are offered for purchase by the retailer, and that are relevant to the search query. In some example, the search algorithms rely on customer data associated with the customer to determine the search results. Customer data may include, for example, customer profile data, purchase data identifying previous purchases of the customer, and user session data identifying previous online events for the user (e.g., impressions, views, advertisement clicks, etc.). As an example, the customer may provide the search query to the website, and the search algorithm may operate on the search query and customer data corresponding to the customer to generate search results (e.g., recommended items) for the customer. The website may display the search results to the customer for purchase consideration.

Often times, however, customer data is not associated with the proper customer. For example, a retailer's database may store multiple sets of customer data, each set associated with a different customer profile. For example, a customer may access a retailer's website using multiple devices at various times. The retailer's system may associate a first set of customer data with a first customer identifier based on the customer's access of the retailer's website using a first device, and may associate a second set of customer data with a second customer identifier based on the customer's access of the retailer's website using a second device. Furthermore, the retailer's system may generate search results based only on the first set of customer data when the customer provides a search query to the retailer's website using the first device, and may generate search results based only on the second set of customer data when the customer provides a search query to the retailer's website using the second device. As a result, the generated search results in either case do not take account of additional customer data that, if considered, may generate more relevant search results for the customer. Further, in some examples, a customer may associated with one set of customer data although the customer is currently engaging in activities attributed to another set of customer data. Thus, there are opportunities to address the association of customer data to customers.

### SUMMARY

The embodiments described herein are, where permitted by law and in accordance with a customer's preferences, directed to associating (e.g., mapping) customer data to a proper customer. For instance, a retailer may maintain, within a database, a plurality of sets of customer data for a plurality of customers. The customer data may characterize, for example, activities conducted on a retailer's website, such as impressions, views, webpage, item, or advertisement clicks, or purchases, for example. Each set of customer data may include an identifier (e.g., and identification number) that associates the customer data to a customer. For example, the identifier may be a household identifier (ID) (e.g., living unity ID), an individual ID, a customer ID, or a cookie stored within a customer's computing device, such as cookie stored within a computer (e.g., visitor tracking cookie) or a cookie stored within a mobile device (e.g., mobile device cookie). The embodiments may associate (e.g., map) customer data with various identifiers to a same customer. Moreover, the embodiments may determine which identifiers of a plurality of identifiers are currently in use by a customer, and associate customer data with the determined identifiers to the customer (e.g., ignoring or setting aside customer data for identifiers not in use by the customer). Based on the associated customer data for a customer, in some examples, search results are generated based on a received search query. Thus, the embodiments may provide a more accurate and comprehensive corpus of customer data for a customer, to be used in any of a variety of applications, such as assisting in complying with data subject requests or to provide search results in response to a search query from the customer.

In accordance with various embodiments, exemplary systems may be implemented in any suitable hardware or hardware and software, such as in one or more suitable computing devices. For example, in some embodiments, a computing device (e.g., server) receives a first identifier of a first type, and a plurality of second identifiers of a second type. The computing device also obtains customer data, such as sales and browsing data, associated with each of the second identifiers, and generates a confidence score for each of the second identifiers based on the corresponding customer data. Further, the computing device generates mapping data that maps the first identifier to one of the plurality of second identifiers based on the confidence scores. In some examples, the computing device determines the mapping data based on temporal intervals associated with the first identifier and each of the plurality of second identifiers. The computing device may store the mapping data within a database. In some examples, the computing device transmits the mapping data, such as to a web server.

In some embodiments, a system includes a database, and a computing device communicatively coupled to the database. The computing device is configured to receive a first identifier of a first type, and a plurality of second identifiers of a second type. The computing device is also configured to determine customer data associated with each of the plurality of second identifiers of the second type. Further, the computing device is configured to generate a confidence score for each of the plurality of second identifiers based on each second identifier's corresponding customer data. The computing device is also configured to generate mapping data that maps the first identifier to one of the plurality of second identifiers based on the confidence scores. The computing device is further configured to store the mapping data within the database.

In some embodiments, a system includes a database, and a computing device communicatively coupled to the database. The computing device is configured to receive a first identifier of a first type, and a plurality of second identifiers of a second type. The computing device is also configured to determine customer data associated with each of the second identifiers of the second type. Further, the computing device is configured to determine a temporal interval associated with the customer data associated with each of the plurality of second identifiers of the second type. The computing device is also configured to generate mapping data that maps the first identifier to one of the plurality of second identifiers based on the temporal intervals. The computing device is further configured to store the mapping data within the database.

In some embodiments, a method by a computing device includes receiving a first identifier of a first type, and a plurality of second identifiers of a second type. The method also includes determining customer data associated with each of the plurality of second identifiers of the second type. Further, the method includes generating a confidence score for each of the plurality of second identifiers based on each second identifier's corresponding customer data. The method also includes generating mapping data that maps the first identifier to one of the plurality of second identifiers based on the confidence scores. The method further includes storing the mapping data within a database.

In some embodiments, a method by a computing device includes receiving a first identifier of a first type, and a plurality of second identifiers of a second type. The method also includes determining customer data associated with each of the second identifiers of the second type. Further, the method includes determining a temporal interval associated with the customer data associated with each of the plurality of second identifiers of the second type. The method also includes generating mapping data that maps the first identifier to one of the plurality of second identifiers based on the temporal intervals. The method further includes storing the mapping data within the database.

In some embodiments, a non-transitory computer readable medium has instructions stored thereon. The instructions, when executed by at least one processor, cause a device to perform operations that include receiving a first identifier of a first type, and a plurality of second identifiers of a second type. The operations also include determining customer data associated with each of the plurality of second identifiers of the second type. Further, the operations include generating a confidence score for each of the plurality of second identifiers based on each second identifier's corresponding customer data. The operations also include generating mapping data that maps the first identifier to one of the plurality of second identifiers based on the confidence scores. The operations further include storing the mapping data within a database

In some embodiments, a non-transitory computer readable medium has instructions stored thereon. The instructions, when executed by at least one processor, cause a device to perform operations that include receiving a first identifier of a first type, and a plurality of second identifiers of a second type. The operations also include determining customer data associated with each of the second identifiers of the second type. Further, the operations include determining a temporal interval associated with the customer data associated with each of the plurality of second identifiers of the second type. The operations also include generating mapping data that maps the first identifier to one of the plurality of second identifiers based on the temporal intervals. The operations further include storing the mapping data within the database.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a customer data mapping system in accordance with some embodiments;

FIG. 2 is a block diagram of an exemplary computing device in accordance with some embodiments;

FIG. 3 is a block diagrams illustrating examples of various portions of the customer data mapping system of FIG. 1 in accordance with some embodiments;

FIG. 4 is a block diagram of a mapping architecture that may be implemented by the customer data mapping system of FIG. 1 in accordance with some embodiments;

FIGS. 5A and 5B illustrate timelines associated with multiple identifiers in accordance with some embodiments;

FIGS. 6A and 6B illustrate mapping graphs in accordance with some embodiments;

FIGS. 7A and 7B illustrate mapping graphs in accordance with some embodiments;

FIG. 8 is a flowchart of an method that can be carried out by the customer data mapping system 100 of FIG. 1 in accordance with some embodiments; and

FIGS. 9A and 9B are flowcharts of other example methods that can be carried out by the customer data mapping system 100 of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

The embodiments may associate (e.g., map) customer data with various identifiers to a same customer. Moreover, the embodiments may determine which identifiers of a plurality of identifiers are currently in use by a customer, and associate customer data with the determined identifiers to the customer (e.g., ignoring or setting aside customer data for identifiers not in use by the customer). Based on the associated customer data for a customer, in some examples, search results are generated based on a received search query.

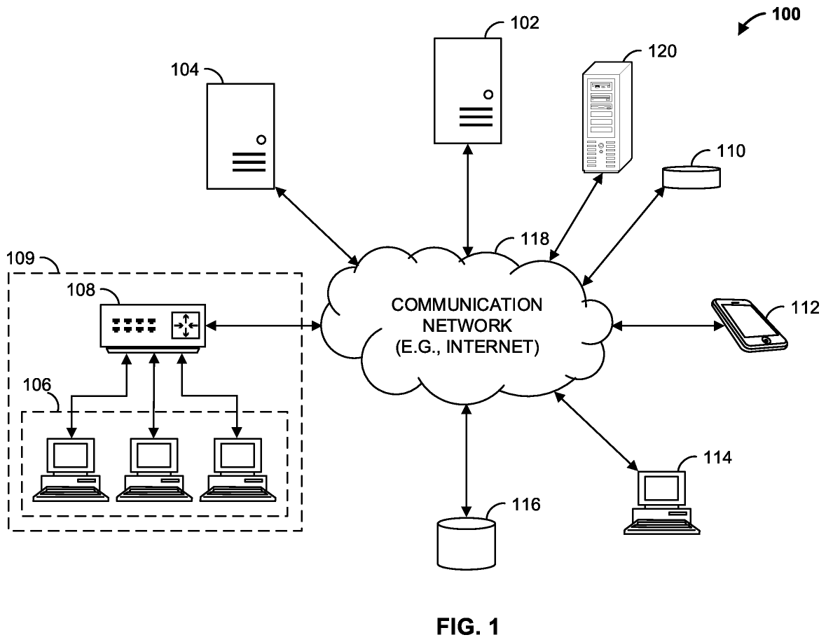

Turning to the drawings, FIG. 1 illustrates a block diagram of a customer data mapping system 100 that includes data mapping computing device 102 (e.g., a server, such as an application server), web server 104, workstation(s) 106, database 116, customer data providing server 120, and multiple customer computing devices 110, 112, 114 operatively coupled over network 118. Data mapping computing device 102, workstation(s) 106, web server 104, customer data providing server 120, and multiple customer computing devices 110, 112, 114 can each be any suitable computing device that includes any hardware or hardware and software combination for processing and handling information. For example, each of data mapping computing device 102, web server 104, workstations 106, customer data providing server 120, and multiple customer computing devices 110, 112, 114 can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, each of data mapping computing device 102, web server 104, and customer data providing server 120 can be a computer, a workstation, a laptop, a server such as a cloud-based server, or any other suitable device. Each of multiple customer computing devices 110, 112, 114 can be a mobile device such as a cellular phone, a laptop, a computer, a table, a personal assistant device, a voice assistant device, a digital assistant, or any other suitable device.

Although FIG. 1 illustrates three customer computing devices 110, 112, 114, customer data mapping system 100 can include any number of customer computing devices 110, 112, 114. Similarly, customer data mapping system 100 can include any number of workstation(s) 106, data mapping computing devices 102, web servers 104, customer data providing servers 120, and databases 116.

Workstation(s) 106 are operably coupled to communication network 118 via router (or switch) 108. Workstation(s) 106 and/or router 108 may be located at a store 109, for example. In some examples, workstation 106 is a register at store 109. Workstation(s) 106 can communicate with data mapping computing device 102 over communication network 118. The workstation(s) 106 may send data to, and receive data from, data mapping computing device 102. For example, the workstation(s) 106 may transmit data related to a transaction, such as a purchase transaction, to data mapping computing device 102. Workstation(s) 106 may also communicate with web server 104. For example, web server 104 may host one or more web pages, such as a retailer's website. Workstation(s) 106 may be operable to access and program (e.g., configure) the webpages hosted by web server 104.

Database 116 can be a remote storage device, such as a cloud-based server, a memory device on another application server, a networked computer, or any other suitable remote storage. Data mapping computing device 102 is operable to communicate with database 116 over communication network 118. For example, data mapping computing device 102 can store data to, and read data from, database 116. Although shown remote to data mapping computing device 102, in some examples, database 116 can be a local storage device, such as a hard drive, a non-volatile memory, or a USB stick.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and N^{th} customer computing device 114 may communicate with web server 104 over communication network 118. For example, web server 104 may host one or more webpages of a website, such as a retailer's website. Each of multiple computing devices 110, 112, 114 may be operable to view, access, and interact with the webpages hosted by web server 104. In some examples, web server 104 hosts a web page for a retailer that allows for the purchase of items. For example, a customer operating one of multiple computing devices 110, 112, 114 may access the web page hosted by web server 104, add one or more items to an online shopping cart of the web page, and perform an online checkout of the shopping cart to purchase the items.

Customer data providing server 120 may provide identifier data to data mapping computing device 102. For example, customer data providing server 120 may be operated by a third party and provide identifier data that maps identifiers (e.g., and, in some examples, corresponding website activities). For example, customer data providing server 120 may transmit to data mapping computing device 102 identifier data that associates one or more living unit IDs, individual IDs, personal IDs, email addresses, beacon tracking cookies, visitor tracking cookies, or any other identifier type to each other.

Data mapping computing device 102 may generate confidence scores characterizing a level of confidence that one identifier, such as a living unit ID, should map to another identifier, such as an individual ID, for a same customer. Based on the confidence scores, data mapping computing device 102 may generate identifier mapping data that maps identifiers to each other. Customer data corresponding to each mapped identifier for a customer may then be employed for various applications, such as for generating search results based on a search query received from the customer. Data mapping computing device 102 may generate the mapping data based on an existing corpus of customer data (e.g., stored in database 116), and, in some examples, identifier data received from customer data providing server 120.

For example, database 116 may store sets of customer data for a plurality of customers. Each set of customer data may include one or more identifiers, where the identifiers may be mapped to other identifiers. As an example, a living unit ID may be mapped to multiple individual IDs when multiple members of a household log in to a retailer's website to purchase items. Because the living unit ID may be tied to an address (e.g., a physical home address), and each of the household members share that address, the living unit ID for the household members may be the same. Moreover, each household member may access the retailer's website from a different computing device at, and thus the retailer may maintain a unique individual ID for each household member. Thus, for example, a living unit ID may be mapped, within the retailer's system, to multiple individual IDs. Similarly, an individual ID may be linked to multiple customer IDs. For example, each customer may maintain one or more accounts (e.g., username and password) with the retailer, where the customer may log into the retailer's website using the accounts. If, for example, a customer has two accounts, the retailer may maintain two customer IDs for the customer, one for each account.

Moreover, each customer ID may be mapped to one or more visitor tracking cookies or mobile device cookies. As an example, the retailer's website may store, within a customer's computing device, such as a computer, a visitor tracking cookie. The retailer's website may identify the visitor tracking cookie when the customer's computing device access the retailer's website. For example, if the customer does not log into their account, rather than attributing activities to a customer ID, the retailer's website may attribute activities to the visitor tracking cookie. Similarly, the retailer's website may store, within a customer's mobile device, such as a cellphone, a mobile device cookie. The retailer's website may identify the mobile device cookie when the customer's mobile device access the retailer's website. For example, if the customer does not log into their account, rather than attributing activities to a customer ID, the retailer's website may attribute activities to the mobile device cookie.

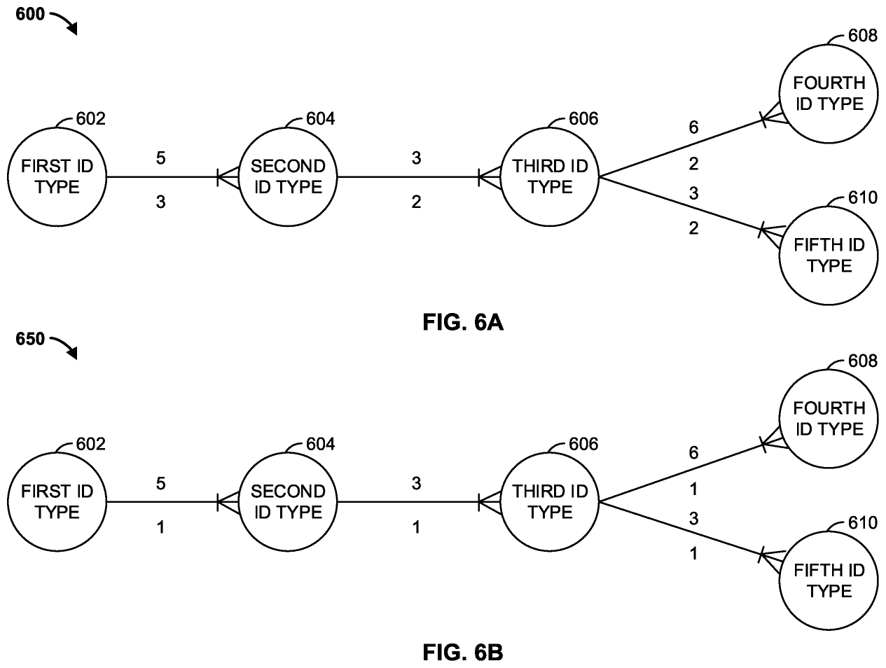

FIG. 6A illustrates an identifier mapping graph 600 that illustrates an average number of mappings between various identifiers of various identifier types including first ID types 602 (i.e., identifiers of a first identifier type), second ID types 604 (i.e., identifiers of a second identifier type), third ID types 606 (i.e., identifiers of a third identifier type), fourth ID types 608 (i.e., identifiers of a fourth identifier type), and fifth ID types 610 (i.e., identifiers of a fifth identifier type). Graph data characterizing identifier mapping graph 600 may be maintained, for example, within a database. Furthermore, each first ID type 602, second ID type 604, third ID type 606, fourth ID type 608, and fifth ID type 610 may be associated with corresponding customer data for a customer.

In this example, the top numbers are average values that correspond to a mapping from left to right, and the bottom numbers are average values that correspond to a mapping from right to left. As illustrated, each first ID type 602 is mapped, on average, to 5 second ID types 604. Each second ID type 604 may be mapped, on average, to 3 third ID types 606. In addition, each third ID type 606 may be mapped, on average, to 6 fourth ID types 608 and to 3 fifth ID types 610.

In some examples, a visitor tracking cookie, or mobile device cookie, may be mapped to more than one customer ID. For example, a computing device may store a first visitor tracking cookie, which may be mapped to a first customer ID. The first visitor tracking cookie may be removed or deleted or even become corrupt, in some examples. As such, when the computing device accesses the retailer's website again, the retailer's website may store a second visitor tracking cookie within the computing device. For example, another customer may use the computing device to browse the retailer's website. The customer may then afterwards log into their account using the computing device, and the retailer's website may associate the second visitor tracking cookie to the customer. As such, the retailer's website may attribute the activities associated with the second visitor tracking cookie to the original customer. For similar reasons, a mobile device cookie may be mapped to multiple customer IDs. Ideally, each visitor tracking cookie and mobile device cookie should, however, be mapped to just one customer ID.

Furthermore, a customer ID may be mapped to multiple individual IDs. For example, a customer, associated with a customer ID, may log in to the retailer's website from various computing devices, where each computing device is associated with an individual ID corresponding to another customer. As a result, the retailer's website may associate the customer's customer ID with each individual ID In some examples, the customer ID is a hashed version of a user ID of credentials used to log into the retailer's website. Ideally, however, each customer ID should be mapped to just one individual ID for a same customer. Similarly, each individual ID may be mapped to more than one living unit ID. For example, a customer associated with an individual ID may use a computing device, such as a computer, at a friend's house to log into the retailer's website using their credentials. The retailer's website may associate the customer's individual ID with the living unit ID of the friend's computing device. In some examples, the customer may live in location for part of the year, and move to another location for the remainder of the year. As such, and assuming the customer logs into the retailer's website from each location, the retailer's website may associate the customer's individual ID with two living unit IDs, one for each location. Ideally, each individual ID should be mapped to one living unit ID.

Referring back to FIG. 6A, identifier mapping graph 600 illustrates that each fourth ID type 608 may be mapped, on average, to 2 third ID types 606, while each fifth ID type 610 may be mapped, on average, to 2 third ID types 606. Further, each third ID type 606 may be mapped, on average, to 2 individual IDs, and each second ID type 604 may be mapped, on average, to 3 first ID types 602. Ideally, however, each fourth ID type 608 and fifth ID type 610 would map to just one third ID type 606. Each third ID type 606 would map to just one second ID type 604, and each second ID type 604 would map to just one first ID type 602.

Referring back to FIG. 1, data mapping computing device 102 may operate on customer data corresponding to identifiers of a mapping graph, such as of identifier mapping graph 600, to generate, based on one or more mapping algorithms (e.g., models), one or more confidence scores between one identifier and each of one or more other identifiers. Based on the confidence scores, data mapping computing device 102 may determine a most likely mapping between the identifier and the one or more other identifiers, and generate mapping data that maps the one identifier to the most likely other identifier (e.g., removing any other mappings between the one identifier and any other of the one or more other identifiers).

For example, assume multiple identifiers of a first type, such as three visitor tracking cookies, map to a same identifier of a second type, such one customer ID. Data mapping computing device 102 may generate a session confidence score for each of the first type of identifiers based on corresponding customer data characterizing one or more customer activities, such as impressions, views (e.g., item views, advertisement views), and clicks (e.g., item clicks, advertisement clicks) performed on the retailer's website and associated with each first type of identifier. Data mapping computing device 102 may, in some examples, generate the session confidence score based on a number of impressions, views, and clicks observed during a temporal interval, such as over the last month, three months, or year. In some examples, the session confidence score is an average daily amount. The higher the amount of customer activity is (e.g., a higher session confidence score), the more likely that the corresponding first type of identifier, over the other first type of identifiers, should be mapped to the second type of identifier.

Moreover, data mapping computing device 102 may generate a sales confidence score for each of the first type of identifiers based on corresponding customer data characterizing sales, such as online sales, associated with each of the first type of identifiers. For example, data mapping computing device 102 may compute one or more of an average number of daily items that are purchased, an average daily order count (e.g., average number of daily orders), and/or an average daily revenue amount (e.g., average daily value of all purchases made in a day). The higher the amount of sales is (e.g., a higher session confidence score), the more likely that the corresponding first type of identifier, over the other first type of identifiers, should be mapped to the second type of identifier.

Data mapping computing device 102 may also generate, in some examples, an active period score, which characterizes a length of time from when activity associated with each of the first type of identifiers was first captured to when activity associated with each of the first type of identifiers was last captured. For example, the active period score may be based on a number of days between when the retailer's website was accessed by a computer storing a visitor tracking cookie to the last time the computer, still storing the visitor tracking cookie, accessed the retailer's webpage. The longer the length of time is (e.g., a higher active period score), the more likely that the corresponding first type of identifier, over the other first type of identifiers, should be mapped to the second type of identifier. In some examples, the active period score can extend for no more than a predetermined period of time, such as a year, or three years. In some examples, customer activity before a predetermined amount of time (e.g., 5 years ago) is not considered (e.g., activity has to be recent within the predetermined amount of time).

Data computing device 102 may further generate, in some examples, a recent activity score, which characterizes a length of time since activity associated with each of the first type of identifiers was last captured. For example, the more recent the last activity captured, the more likely that the corresponding first type of identifier, over the other first type of identifiers, should be mapped to the second type of identifier. In some examples, data computing device 102 determines the length of time in days, and subtracts the determined length of time from a predetermined maximum value (e.g., 100, 365, etc.) to generate the recent activity scores. As such, a higher recent activity score indicates more recent activity. In some examples, customer activity before a predetermined amount of time (e.g., 5 years ago) is not considered (e.g., activity has to be recent within the predetermined amount of time).

Based on one or more of the session confidence score, sales confidence score, active period score, and recent activity score for each of the first type of identifiers, data computing device 102 may map one of the first type of identifiers to the second type of identifier. For example, data computing device 102 may generate a final score for each of the first type of identifiers based on their corresponding the session confidence scores, sales confidence scores, active period scores, and recent activity scores.

To generate the final scores, data computing device 102 may apply suitable algorithm to the session confidence score, sales confidence score, active period score, and recent activity score. For example, data computing device 102 may add the scores, take an average of the scores, or apply a trained machine learning process (e.g., model) to the scores. In some examples, data computing device 102 applies a weight (e.g., scaling value) to each of the session confidence score, sales confidence score, active period score, and recent activity score for each of the first type of identifiers, and generates the final score based on the corresponding weighted scores.

In some examples, data computing device 102 eliminates any mappings with corresponding final scores below a threshold (e.g., 0.5 on a scale of 0 to 1, inclusive), and keeps the mapping with the highest remaining final score. If no final scores remain (e.g., all scores were below the threshold value), no mapping is made between the two identifiers.

In some examples, data computing device 102 eliminates any mappings with corresponding final scores below a threshold, and determines a timestamp associated with any remaining mappings. The timestamp may a date and time of last captured activity for each identifier being mapped. Data computing device 102 may select the mapping with a timestamp indicating the most recent activity.

As an example, and in continuance of the above example, rather than having the three visitor tracking cookies map to one customer ID, data computing device 102 would map just one of the three visitor tracking cookies to the customer ID. The other two visitor tracking cookie would not map to the customer ID, and instead may be mapped to other customer IDs, or not mapped to any customer IDs.

For example, FIG. 6B illustrates an identifier mapping graph 650 that illustrates an average number of mappings between various identifiers including first ID types 602, second ID types 604, third ID types 606, fourth ID types 608, and fifth ID types 610. Here, however, data computing device 102 generated final scores as described above and, based on the final scores, mapped each visitor tracking cookie 608 and fifth ID type 610 to just one third ID type 606, each third ID type 606 to just one second ID type 604, and each second ID type 604 to just one first ID type 602. Each third ID type 606, however, can be mapped to one or more fourth ID types 608, and one or more fifth ID types 610. Here, for example, each third ID type 606 remains mapped, on average, to 6 fourth ID types 608 and 3 fifth ID types 610. Furthermore, each third ID type 606 is mapped to just one second ID type 604, but each second ID type 604 remains mapped, on average, to 3 third ID types 606. Similarly, each second ID type 604 is mapped to just on first ID type 602, but each first ID type 602 remains mapped, on average, to 5 second ID types 604.

Referring back to FIG. 1, data computing device 102 may update identifier mapping data characterizing mappings between various types of identifier types for a customer on an occasional (e.g., periodic, nightly, monthly) basis. For example, web server 104 and stores 109 may update customer data within database 116 in real-time. Data computing device 102 may, on a nightly basis, obtain corresponding customer data for a plurality of customers from database 116, generate the final scores based on the updated customer data, and update the identifier mapping data based on the final scores.

Based on the updated identifier mapping data, data computing device 102 may generate results for customers. For example, a customer may, using a customer computing device 110, 112, 114, access a retailer's website hosted by web server 104. The customer may, for example, provide a search query within a search bar of the website. In response, web server 104 may transmit a search query request to data computing device 102, which characterizes the search query and further identifies the customer (e.g., via an individual ID, customer ID, or mobile device cookie). Data computing device 102 may determine, based on the updated identifier mapping data, all customer data corresponding to the identified customer (e.g., by determining an identifier matching a received identifier, and determining the customer data for each identifier mapped to the determined identifier). Based on at least a portion of the determined customer data for the customer, data computing device 102 may generate search results in response to the search query. For example, data computing device 102 may apply one or more trained machine learning processes to the identified customer data to generate the search results. Data computing device 102 may then transmit the search results to web server 104 for display to the customer.

In some examples, data computing device 102 may apply one or more trained machine learning processes to the identified customer data to determine item advertisements to display to the customer. For example, web server 104 may transmit a request for item advertisements, where the request identifies the customer. Data computing device 102 may determine, based on the updated identifier mapping data, all customer data corresponding to the identified customer, and may further apply the one or more trained machine learning processes to the identified customer data to determine the item advertisements. Data computing device 102 may then transmit the item advertisements to web server 104 for display to the customer.

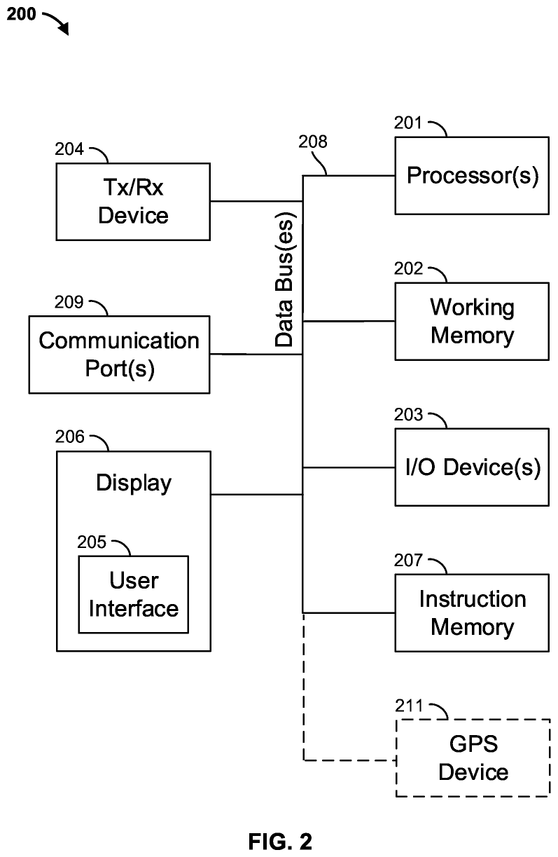

FIG. 2 illustrates an exemplary computing device 200, such as the data mapping computing device 102 or customer computing devices 110, 112, 114 of FIG. 1. Computing device 200 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of data mapping computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as identifier mapping data.

Display 206 can display user interface 205. User interfaces 205 can enable user interaction with data mapping computing device 102. For example, user interface 205 can be a user interface for an application of a retailer that allows a customer to purchase one or more items from the retailer. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 data mapping computing device 102 will be operating in. Processor(s) 201 is operable to receive data from, or send data to, a network, such as communication network 118 of FIG. 1, via transceiver 204.

In some examples, computing device 200 includes a global position system (GPS) device 211. GPS device 211 can determine location information, such as latitude and longitude, of computing device 200. Processor 201 may receive the location information from GPS device 211, and can display the location information within display 206. In some examples, an application executed by customer computing devices 110, 112, 114 transmits the location information to data mapping computing device 102. Data mapping computing device 102 may generate features based on the received location information.

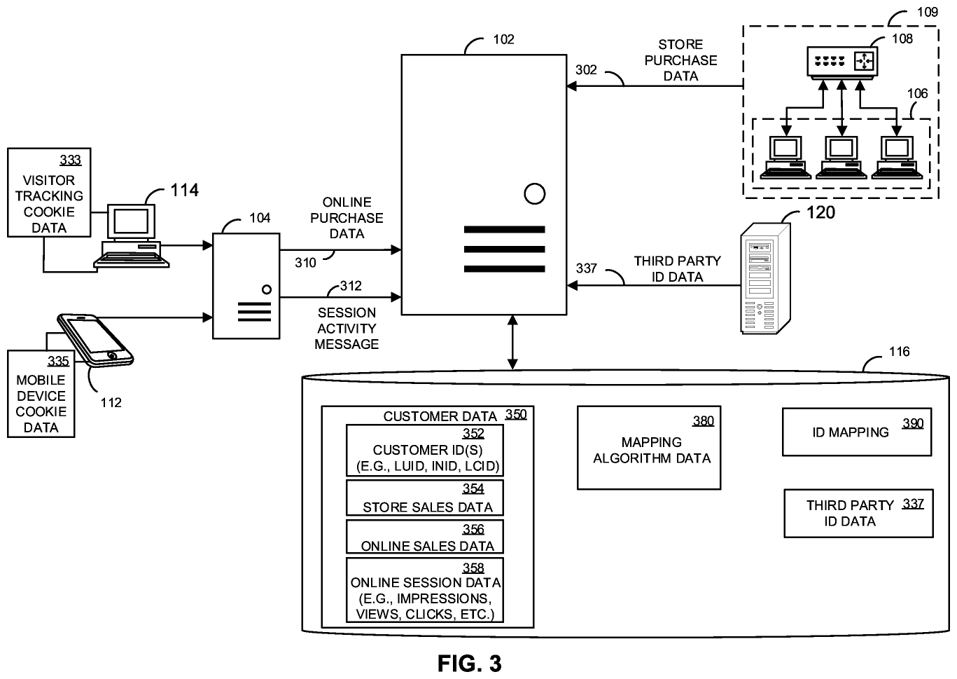

FIG. 3 is a block diagram illustrating examples of various portions of the customer data mapping system 100 of FIG. 1. In this example, data mapping computing device 102 can receive from a store 109 (e.g., from a computing device, such as workstation 106, at store location 109) store purchase data 302 identifying the purchase attempt of one or more items. Store purchase data 302 may include, for example, one or more of the following: an identification of one or more items being purchased; an identification of the customer (e.g., customer ID, passport ID, driver's license number, etc.); an image of an identification of the customer; an identification of a device being used for the purchase (e.g., a device ID, a user name for an application running on the device, a MAC address, etc.); a monetary amount (e.g., price) of each item being returned; the method of payment (i.e., payment form) used to purchase the items (e.g., credit card, cash, check); a Universal Product Code (UPC) number for each item; a time and/or date; and/or any other data related to the attempted purchase transaction. Data mapping computing device 102 may parse store purchase data 302, determine a customer associated with the purchase (e.g., via the identification of the customer, such as an identifier, home address, phone number, etc.), and store the parsed data as store sales data 354 within a customer data 350 portion of database 116. Further, data mapping computing device 102 may map the store sales data 354 to one or more customer identifiers 352 stored within the customer data 350 portion of database 116. Customer identifiers 352 may include one or more identifiers of one or more identifier types (e.g., individual IDs, living unit IDs, customer IDs, tracking cookies, email address, etc.). For example, data mapping computing device 102 may determine a customer identifier 352 that matches a received customer identifier, and map the store sales data 354 to the matched customer identifier.

Similarly, data mapping computing device 102 can receive from a web server 104, such as a web server hosting a retailer's website, online purchase data 310 identifying the purchase attempt of one or more items from the website. For example, web server 104 may receive purchase request data 306 from customer computing device 112, where purchase request data 306 identifies an attempt to purchase one or more items from a website, such as a retailer's website. Web server 104 may generate online purchase data 310 based on purchase request data 306. For example, online purchase data 310 may include one or more of the following: an identification of one or more items being purchased; an identification of the customer (e.g., customer ID, individual ID, customer ID, a user name, a driver's license number, etc.); an identification of a device (e.g., a computer, mobile phone, etc.) being used for the purchase (e.g., a device ID, a user name for an application running on the device, a MAC address, etc.); a monetary amount (e.g., price) of each item being returned; the method of payment (i.e., payment form) used to purchase the items (e.g., credit card, cash, check); a Universal Product Code (UPC) number for each item; a time and/or date; and/or any other data related to the attempted purchase transaction. Data mapping computing device 102 may parse online purchase data 310, determine a customer associated with the purchase (e.g., via the identification of the customer, such as individual ID, customer ID, etc.), and store the parsed data as online sales data 356 within the customer data 350 portion of database 116. Further, data mapping computing device 102 may map the online sales data 356 to one or more of the customer identifiers 352.

Data mapping computing device 102 may also receive, from web server 104, online session data 358 for a customer accessing (e.g., browsing) a website hosted by web server 104. For example, a customer may access the website using a first customer computing device 114, which may store visitor tracking cookie data 333 characterizing a tracking cookie. Web server 104 may determine customer activities on the website such as impressions, views, and clicks, and generate a session activity message 312 that characterizes the tracking cookie data 333 and the customer activities. Web server 104 may then transmit the session activity message 312 to data mapping computing device 102.

Similarly, a customer may access the website using a second customer computing device 112, which may store mobile device cookie data 335 characterizing a mobile device cookie. Web server 104 may determine customer activities on the website such as impressions, views, and clicks, and generate a session activity message 312 that characterizes the mobile device cookie data 335 and the customer activities. Web server 104 may then transmit a session activity message 312 to data mapping computing device 102.

Data mapping computing device 102 may parse a received session activity message 312 to extract online session data 358, and store online session data 358 within the customer data 350 portion of database 116. Data mapping computing device 102 may also extract a tracking cookie from tracking cookie data 333 or a mobile device cookie from mobile device cookie data 335, and may store the extracted visitor tracking cookie or mobile device cookie within customer identifiers 352. Further, data mapping computing device 102 may map the online session data 358 to one or more of the customer identifiers 352 based on, for example, the received identifier (e.g., tracking cookie data 333, mobile device cookie data 335).

In some examples, data mapping computing device 102 receives third party ID data 337 from customer data providing server 120, and stores third party ID data 337 within database 116. Third party ID data 337 may characterize an identifier mapping as recognized by a third party provider operating customer data providing server 120.

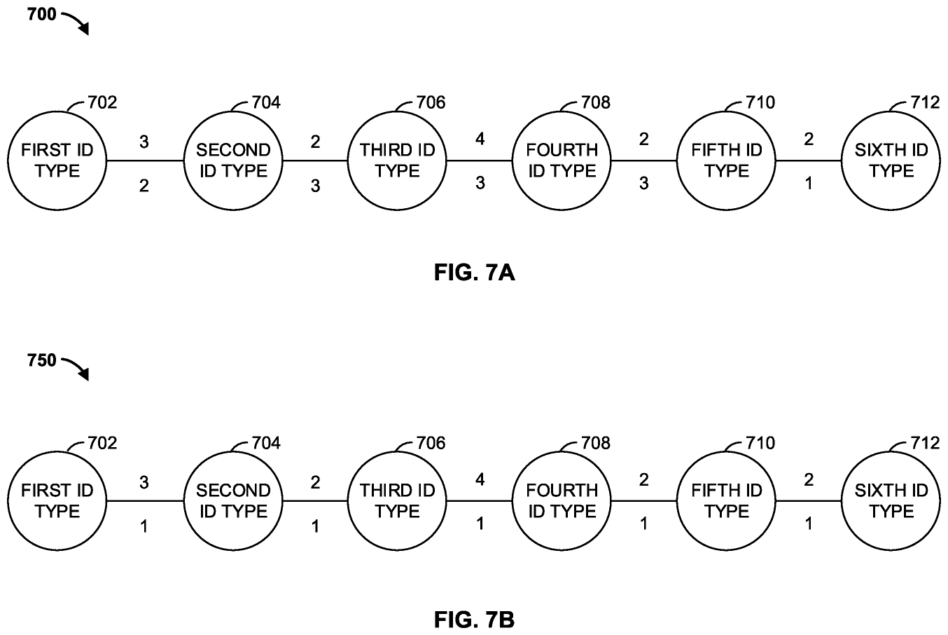

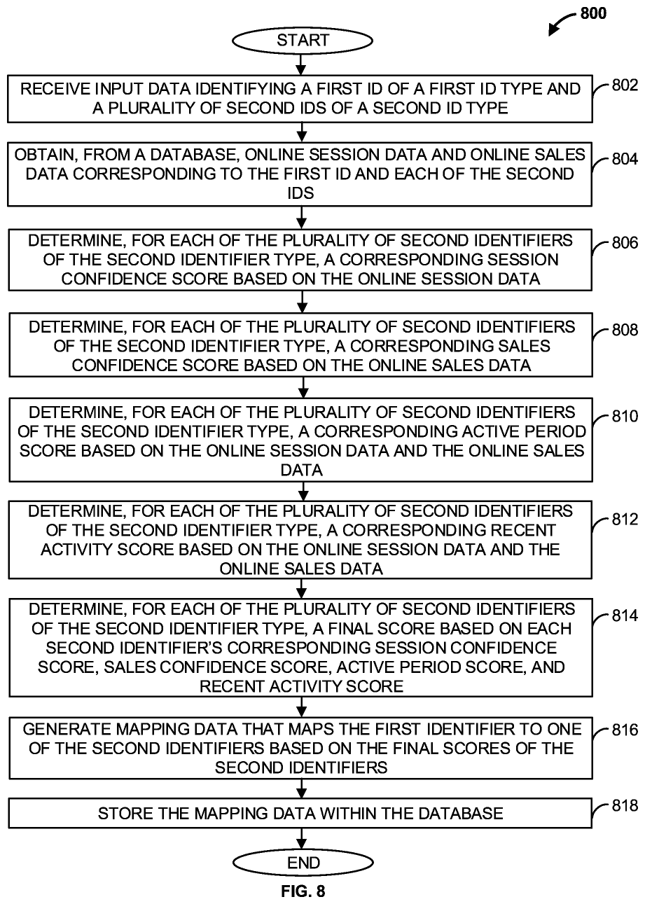

For example, FIG. 7A illustrates a third party identifier mapping graph 700 that illustrates an average number of mappings between various identifiers based on mapping data received by data mapping computing device 102 from customer data providing server 120. Third party identifier mapping graph 700 illustrates an average number of mappings between identifiers of various identifier types including first ID types 702 (e.g., living unit IDs), second ID types 704 (e.g., individual IDs), third ID types 706 (e.g., personal IDs), fourth ID types 708 (e.g., email addresses), fifth ID types 710 (e.g., Bluetooth beacon tracking cookies), and sixth ID types 712 (e.g., visitor tracking cookies). Third party identifier mapping graph 700 may be maintained, for example, within a database, and may be generated based on mapping data received from customer data providing server 120. Furthermore, each first ID type 702, second ID type 704, third ID type 706, fourth ID type 708, fifth ID types 710, and sixth ID type 712 may be associated with corresponding customer data for a customer.

In this example, the top numbers are average values that correspond to a mapping from left to right, and the bottom numbers are average values that correspond to a mapping from right to left. As illustrated, each first ID type 702 is mapped, on average, to 3 second ID types 704. Further, each second ID type 704 is mapped to 2 third ID types 706, and each third ID type 706 is mapped, on average, to 4 fourth ID types 708. Each fourth ID type 708 is mapped, on average, to 2 fifth ID types 710, and each fifth ID type 710 is mapped, on average, to 2 sixth ID types 712.

In addition, each sixth ID type 712 is mapped, on average, to 1 fifth ID type 710. Each fifth ID type 710 is mapped, on average, to 3 fourth ID types 708. In addition, each fourth ID type 708 is mapped, on average, to 3 third ID types 706, each third ID type 706 is mapped, on average, to 3 second ID types 704, and each second ID type 704 is mapped, on average, to 2 first ID types 702.

Data mapping computing device 102 may perform operations to generate mapping data that maps one identifier of a plurality of identifiers of one type to another identifier of another type. For example, data mapping computing device 102 may map each sixth ID type 712 to one fifth ID type 710, each fifth ID type 710 to one fourth ID type 708, each fourth ID type 708 to one third ID type 706, each third ID type 706 to one second ID type 704, and each second ID type 704 to one first ID type 702. To generate the mapping data, data mapping computing device 102 may determine one or more scores for each of a plurality of identifiers of a first type based on corresponding customer data (e.g., customer data 390), and map one of the plurality of identifiers of the first type to an identifier of a second type.

For example, and with reference back to FIG. 3, data mapping computing device 102 may generate, for each of the plurality of identifiers of the first type, a session confidence score, a sales confidence score, an active period score, and a recent activity score. Data mapping computing device 102 may then generate, for each of the plurality of identifiers of the first type, a final score based on the session confidence score, sales confidence score, active period score, and recent activity score. For example, data mapping computing device 102 may apply a predetermined weight to each of the session confidence score, sales confidence score, active period score, and recent activity score, and combine the weighted scores to generate the final score. Further, and based on the final scores, data mapping computing device 102 may determine an identifier of the first type to map to the second identifier.

To determine mappings between various identifiers of customer identifiers 352, data mapping computing device 102 may apply one or more mapping algorithms to generate confidence scores. For example, mapping algorithm data 380 may identify and characterize one or more of the mapping algorithms. Data mapping computing device 102 may obtain mapping algorithm data 380, extract a mapping algorithm, and apply the mapping algorithm to customer data 350 to generate confidence scores (e.g., session confidence scores, sales confidence scores, active period scores, recent activity scores, and final scores) between each of a first type of identifier mapped to a same second type of identifier.

For example, FIG. 7B illustrates a third party identifier mapping graph 750 that illustrates an average number of mappings between various identifiers based on performing operations on mapping data received from customer data providing server 120, such as the mapping data characterized by third party identifier mapping graph 700 of FIG. 7A, to generate mapping data that maps one identifier of a plurality of identifiers of one type to another identifier of another type. In this example, data mapping computing device 102 maps each sixth ID type 712 to one fifth ID type 710 based on final scores generated for sixth ID types 712. Further, data mapping computing device 102, based on final scores generated for fifth ID types 710, maps each fifth ID type 710 to just one fourth ID type 708. In addition, data mapping computing device 102 maps each fourth ID type 708 aps to just one third ID type 706 based on final scores generated for fourth ID types 708. In addition, data mapping computing device 102, based on final scores generated for third ID type 706, maps each third ID type 706 to just one second ID type 704. Finally, data mapping computing device 102 maps each second ID type 704 to just one first ID type 702 based on final scores generated for second ID types 704.

In this example, each first ID type 702 remains mapped, on average, to 3 second ID types 704. Further, second ID type 704 remains mapped, on average, to 2 third ID types 706, and each third ID type 706 remains mapped, on average, to 4 fourth ID types 708. Further, each fourth ID type 708 remains mapped, on average, to 2 fifth ID types 710, and each fifth ID type 710 remains mapped, on average, to 2 sixth ID types 712.

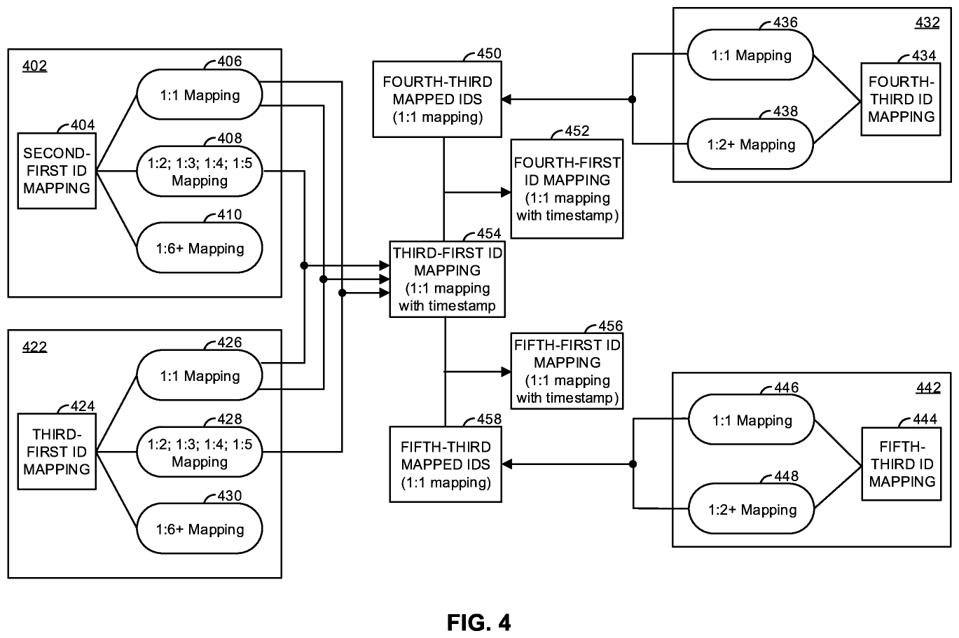

FIG. 4 illustrates an exemplary architecture 400 that data mapping computing device 102 may employ to associate identifiers of various types. Architecture 400 includes an individual ID-living unit ID mapping engine 402, an customer ID-individual ID mapping engine 422, a fourth-third ID mapping engine 432, a fifth-third ID mapping engine 442, a fourth-first ID mapping engine 452, a third-first ID mapping engine 454, and a fifth-first ID mapping engine 456. In some examples, any of the engines may be implemented in hardware. In some examples, any of the engines may be implemented as an executable program maintained in a tangible, non-transitory memory, such as instruction memory 207 of FIG. 2, which may be executed by one or processors, such as processor 201 of FIG. 2.

Individual ID-living unit ID mapping engine 402 includes a second-first ID mapping module 404 that determines, for each of a plurality of individual IDs, one or more living unit IDs that each individual ID is mapped to over a temporal interval of customer activity. For example, second-first ID mapping module 404 may determine whether an individual ID is mapped to one living unit ID (e.g., 1:1 mapping 406), to multiple living unit IDs up to a predetermined threshold (e.g., 1:2; 1:3; 1:4; 1:5 mapping 408), or a number of living unit IDs above the predetermined threshold. The predetermined threshold may be, for example, five living unit IDs. If the number of number of determined living unit IDs is above the predetermined threshold, in some examples, the individual ID is not mapped to any of the living unit IDs. If there is only one individual ID and one living unit ID (e.g., 1:1 mapping 406), the individual ID is mapped to the one living unit ID during the temporal period of customer activity. If, however, there are multiple living unit IDs that may be mapped to the individual ID during the temporal period (e.g., 1:2; 1:3; 1:4; 1:5 mapping 408), second-first ID mapping module 404 may perform operations to determine a one-to-one individual ID-living unit ID mapping at any point in time during the temporal interval.

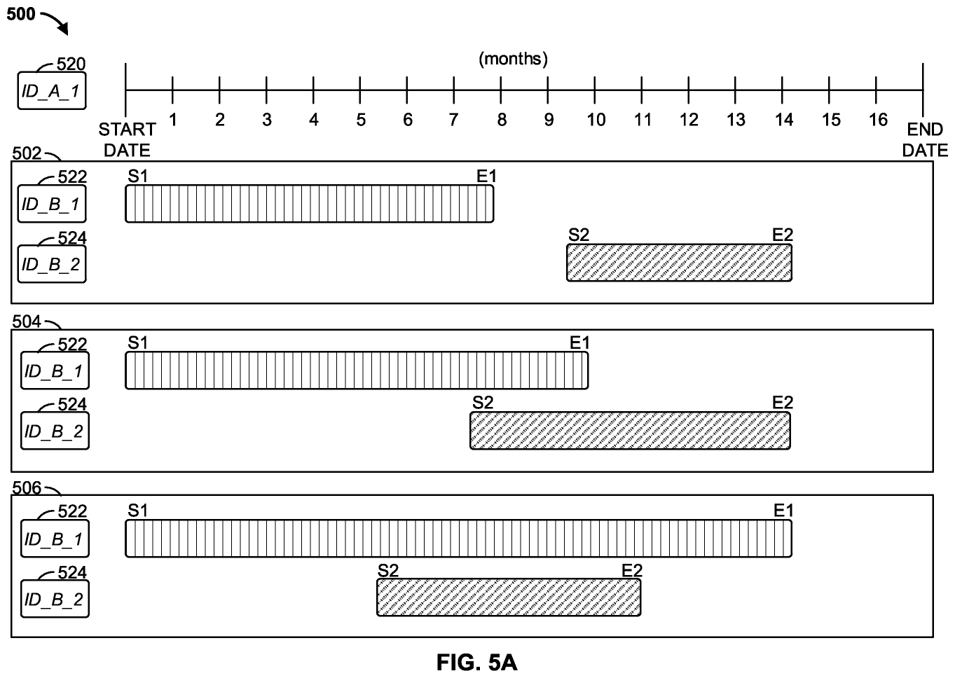

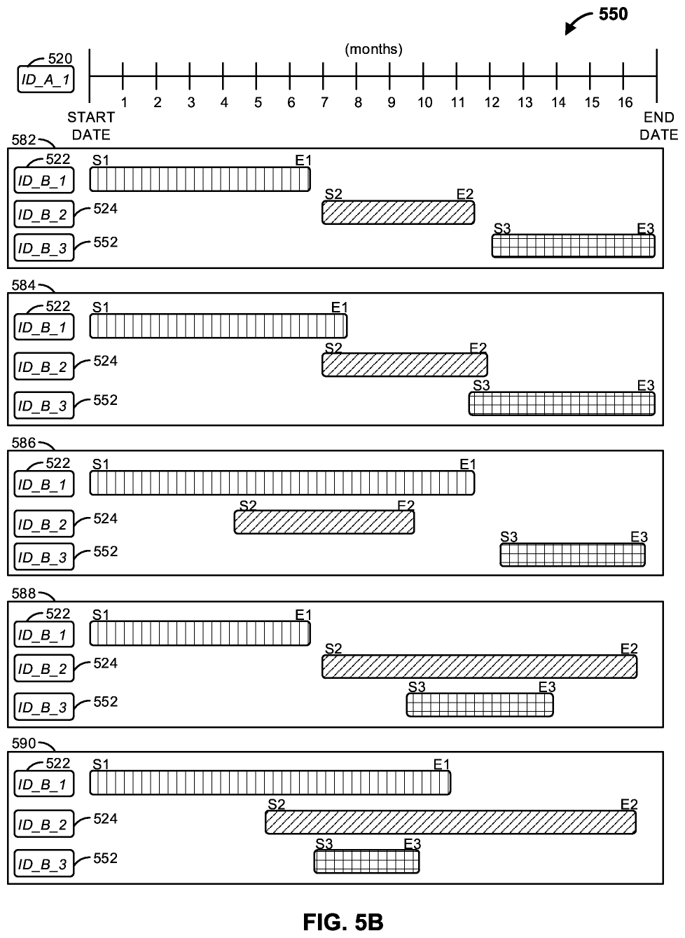

For example, FIG. 5A illustrates a timeline 500 that spans months from a start date to an end date during which an individual ID_A_1 520 identifier type is attributed to customer data (e.g., customer data 390), and during which the customer data is also attributed to two living unit IDs, namely living unit ID_B_1 522 and ID_B_2 524 identifier types (e.g., a 1:2 individual ID-living unit ID mapping). Further, timeline 500 illustrates a plurality of situations 502, 504, 506, 508, 510 in which ID_A_1 520 is attributed to customer data from a starting date of START DATE to an ending date of END DATE. Each date may be associated with a timestamp (e.g., date and time corresponding to customer activity, such as a date and time of an online purchase, impression, view, or store purchase). During this time, ID_A_1 520 is associated with a first ID_B_1 522 and a second ID_B_2 524.

In situation 502, first ID_B_1 522 is attributed to customer data from a starting date S1 (e.g., a “first seen” date) to an end date E1 (e.g., a “last seen” date). Similarly, second ID_B_2 524 is attributed to customer data from a starting date S2 to an end date E2. In this example, the time periods attributed to first ID_B_1 522 and second ID_B_2 524 (as indicated by times S1, E1, and S2, E2 bar graphs) never overlap. As such, third-first ID mapping engine 454 may map activities from time S1 up until time S2 to ID_B_1 522 (e.g., set E1= to S2), and any later customer activities to ID_B_2 524. In other words, any customer activities from the START DATE until time S2 is attributed to ID_B_1 522, and any customer activities starting at time S2 and later is attributed to ID_B_2 524. In this manner, at any point in time, ID_A_1 520 is mapped to just one living unit ID (i.e., ID_B_1 522 up until S2, and ID_B_2 524 starting from time S2 and later). For example, individual ID-living unit ID mapping engine 402 may determine that time E1 is at the same time, or earlier, and perform the mapping.

In situation 504, time E1 for ID_B_1 522 occurs later than time S2 for ID_B_2 524. A customer, for example, may have lived at two different addresses during that period. In any event, in this example, individual ID-living unit ID mapping engine 402 may map activities from time S1 up until time S2 to ID_B_1 522 (e.g., set E1= to S2). In other words, any customer activities from the START DATE until time S2 is attributed to ID_B_1 522, and any customer activities starting at time S2 and later is attributed to ID_B_2 524. Thus, although there was activity for both ID_B_1 522 and ID_B_2 524 between times S2 and E1, that customer activity will be attributed to ID_B_1 522. In this manner, at any point in time, ID_A_1 520 is mapped to just one living unit ID (i.e., ID_B_1 522 up until S2, and ID_B_2 524 starting from time S2 and later). For example, individual ID-living unit ID mapping engine 402 may determine that time E1 is at the same time, or later, than time S2, but before time E2, and perform the above noted mapping.

In situation 506, the time period for ID_B_2 524 (i.e., as indicated by times S2, E2) fall within the time period for ID_B_1 522 (i.e., as indicated by times S1, E1). A customer, for example, may have lived temporarily at an address corresponding to ID_B_2 524, such as when a student lives on campus during a college school year. The customer, however, lived at the address corresponding to ID_B_1 522 before the S2, E2 time period, as well as after the S2, E2 time period. In this example, individual ID-living unit ID mapping engine 402 attributes all customer activity from the TART DATE to the END DATE to ID_B_1 522. On other words, the “temporary housing” will be ignored, and even during the time period S2, E2, the corresponding customer activity is attributed to ID_B_1 522.

FIG. 5B illustrates a timeline 550 that spans months from a start date to an end date during which an ID_A_1 520 is attributed to customer data (e.g., customer data 390), and during which the customer data is also attributed to three living unit IDs, namely ID_B_1 522, ID_B_2 524, and ID_B_3 552 (e.g., a 1:3 individual ID-living unit ID mapping). Individual ID-living unit ID mapping engine 402 may perform operations to map ID_A_1 520 to just one of ID_B_1 522, ID_B_2 524, and ID_B_3 552 in each of situations 582, 584, 586, 588, and 590. ID_B_1 522 is attributed to customer activity that takes place from time S1 to time E1, while ID_B_2 524 is attributed to customer activity that takes place from time S2 to time E2, and ID_B_3 552 is attributed to customer activity that takes place from time S3 to time E3.

In situation 582, no time periods associated with ID_B_1 522, ID_B_2 524, and ID_B_3 552. In this example, individual ID-living unit ID mapping engine 402 may map customer activities from time S1 up until time S2 to ID_B_1 522 (e.g., set E1= to S2). In addition, individual ID-living unit ID mapping engine 402 may map customer activities from time S2 up until time S3 to ID_B_2 524 (e.g., set E2= to S3). Further, individual ID-living unit ID mapping engine 402 may map any later customer activities to ID_B_3 552. In other words, any customer activities from the START DATE until time S2 are mapped (e.g., attributed) to ID_B_1 522, any customer activities from time S2 to time S3 are mapped to ID_B_2 524, and any customer activities starting at time S3 and later are mapped to ID_B_3 552. In this manner, at any point in time, ID_A_1 520 is mapped to just one living unit ID (i.e., ID_B_1 522 up until time S2, ID_B_2 524 up until time S3, and ID_B_3 552 starting from time S3 and later). For example, individual ID-living unit ID mapping engine 402 may determine that time E1 is at the same time, or earlier, than time S2, and further that time E2 is at the same time, or earlier than, time S3, and perform the above noted mapping.

In situation 584, individual ID-living unit ID mapping engine 402 may similarly map customer activities from time S1 up until time S2 to ID_B_1 522 (e.g., set E1= to S2). In addition, customer ID-individual ID-living unit ID mapping engine 402 may map customer activities from time S2 up until time S3 to ID_B_2 524 (e.g., set E2= to S3), and any customer activities from time S3 onwards to ID_B_3 552. For example, individual ID-living unit ID mapping engine 402 may determine that time E1 is at the same time, or later, than time S2, but before time E2. Further, individual ID-living unit ID mapping engine 402 may determine that time E2 is at the same time, or later than, time S3, but before time E3. Based on these determinations, individual ID-living unit ID mapping engine 402 may perform the above noted mapping.

In situation 586, the time period associated with ID_B_1 522 (e.g., as defined by times S1, E1) completely overlaps the time period associated with ID_B_2 524 (e.g., as defined by times S2, E2). As such, individual ID-living unit ID mapping engine 402 may map all customer activities from S1 to S3 to ID_B_1 522 (e.g., E1=S3). Moreover, individual ID-living unit ID mapping engine 402 may map all customer activities from time S3 and onwards to ID_B_3 552. In this manner, at any point in time, ID_A_1 520 is mapped to just one living unit ID (i.e., ID_B_1 522 up until time S3, and ID_B_3 552 starting from time S3 and later). For example, individual ID-living unit ID mapping engine 402 may determine that time S2 is at the same time, or later than, time S1, and that time E2 is at the same time, or earlier than, time E1, and thus determine that the time period for ID_B_1 522 includes (e.g., completely covers) the time period for ID_B_2 524. Further, individual ID-living unit ID mapping engine 402 may determine that time E1 is earlier than time E3. Based on these determinations, individual ID-living unit ID mapping engine 402 may perform the above noted mapping.

Situation 588 is similar to situation 586, although the time period for ID_B_2 524 (e.g., as defined by times S2, E2) includes the time period associated with ID_B_3 552 (e.g., as defined by times S3, E3). Thus, in this example, individual ID-living unit ID mapping engine 402 may map all customer activities from S1 to S2 to ID_B_1 522 (e.g., E1=S2). Moreover, individual ID-living unit ID mapping engine 402 may map all customer activities from time S2 and onwards to ID_B_2 524. Thus, ID_B_3 552 is not attributed to any customer activities. In this manner, at any point in time, ID_A_1 520 is mapped to just one living unit ID (i.e., ID_B_1 522 up until time S2, and ID_B_2 524 starting from time S2 and later). For example, individual ID-living unit ID mapping engine 402 may determine that time S3 is at the same time, or later than, time S2, and that time E3 is at the same time, or earlier than, time E2, and thus determine that the time period for ID_B_2 524 includes the time period for ID_B_3 552. Further, individual ID-living unit ID mapping engine 402 may determine that time E1 is earlier than time E2. Based on these determinations, individual ID-living unit ID mapping engine 402 may perform the above noted mapping.

Situation 590 is a situation where the time periods associated with each of ID_B_1 522 (e.g., times S1, E1) and ID_B_2 524 (e.g., times S2, E2) cover the time period associated with ID_B_3 552 (e.g., times S3, E3). In this example, individual ID-living unit ID mapping engine 402 may map the customer activities during the time period associated with ID_B_3 552 (e.g., time period S3 to E3) to ID_B_2 524. For example, individual ID-living unit ID mapping engine 402 may determine that time S1 is earlier than time S2, and that time E1 is at the same time, or later than, time S2, and earlier than time E2. As such, individual ID-living unit ID mapping engine 402 may map all customer activities from time S1 until time S2 to ID_B_1 522 (e.g., set E1= to S2). Then because the customer activities attributed to ID_B_3 552 would only be covered by the time period associated with ID_B_2 524 (e.g., as the time period mapped to ID_B_1 522 now ends at time S2), individual ID-living unit ID mapping engine 402 may map all activities associated with ID_B_3 552 to ID_B_2 524. Thus, individual ID-living unit ID mapping engine 402 may map customer activities from S1 to S2 to ID_B_1 522, and any activities from S2 and onward to ID_B_3 552.

Referring back to FIG. 4, third-first ID mapping engine 422 includes a third-first ID mapping module 424 that similarly determines, for each of a plurality of customer IDs, a number of individual IDs that each customer ID is mapped to over a temporal interval of customer activity. For example, third-first ID mapping module 424 may determine whether an living unit ID is mapped to one individual ID (e.g., 1:1 mapping 426), to multiple individual IDs up to a predetermined threshold (e.g., 1:2; 1:3; 1:4; 1:5 mapping 428), or a number of individual IDs above the predetermined threshold. The predetermined threshold may be, for example, five individual IDs. If the number of number of determined individual IDs is above the predetermined threshold, in some examples, the customer ID is not mapped to any of the individual IDs. If there is only one customer ID and one individual ID (e.g., 1:1 mapping 426), the customer ID is mapped to the one individual ID during the temporal period of customer activity. If, however, there are multiple individual IDs that may be mapped to the customer ID during the temporal period (e.g., 1:2; 1:3; 1:4; 1:5 mapping 428), third-first ID mapping module 424 may perform operations similar to those described above with respect to FIGS. 5A and 5B to determine a one-to-one customer ID-living unit ID mapping at any point in time during the temporal interval

Third-first ID mapping engine 454 may receive, for the temporal period, an individual ID-living unit ID mapping (e.g., 1:1 individual ID-living unit ID mapping) from individual ID-living unit ID mapping engine 402, and an customer ID-individual ID mapping (e.g., 1:1 customer ID-individual ID mapping) from customer ID-individual ID mapping engine 422. Further, third-first ID mapping engine 454 may determine a customer ID-living unit ID mapping based on the received individual ID-living unit ID mapping and customer ID-individual ID mapping. For example, assuming third-first ID mapping engine 454 receives a 1:1 individual ID-living unit ID mapping and a 1:1 customer ID-individual ID mapping for the temporal period, third-first ID mapping engine 454 maps the one customer ID to the one living unit ID during the temporal period.

Further, fourth-third ID mapping engine 432 includes a visitor tracking cookie-customer ID module 434 that similarly determines, for each of a plurality of visitor tracking cookies, a number of customer IDs that each visitor tracking cookie is mapped to over a temporal interval of customer activity. For example, visitor tracking cookie-customer ID module 434 may determine whether a visitor tracking cookie is mapped to one customer ID (e.g., 1:1 mapping 436) or to multiple customer IDs (e.g., 1:2+ mapping 438). If there is only one visitor tracking cookie and one customer ID (e.g., 1:1 mapping 436), the visitor tracking cookie is mapped to the one customer ID during the temporal period of customer activity. If, however, there are multiple customer IDs that may be mapped to the visitor tracking cookie during the temporal period (e.g., 1:2+ mapping 438), visitor tracking cookie-customer ID module 434 may perform operations similar to those described above with respect to FIGS. 5A and 5B to determine a one-to-one visitor tracking cookie-customer ID mapping at any point in time during the temporal interval. Fourth-third ID mapping engine 432 generates fourth-third mapped IDs 450 characterizing the 1:1 visitor tracking cookie-customer ID mapping over the temporal period.

Fourth-first ID mapping engine 452 may receive, for the temporal period, fourth-third mapped IDs 450 from fourth-third ID mapping engine 432, and receive the customer ID-living unit ID mapping from third-first ID mapping engine 454. Fourth-first ID mapping engine 452 may perform operations to generate a visitor tracking cookie-living unit ID mapping based on the received fourth-third mapped IDs 450 and customer ID-living unit ID mapping. For example, assuming fourth-first ID mapping engine 452 receives a 1:1 visitor tracking cookie-customer ID mapping and a 1:1 customer ID-living unit ID mapping for the temporal period, fourth-first ID mapping engine 452 maps the one visitor tracking cookie to the one living unit ID during the temporal period. In some examples, to map a visitor tracking cookie to one of a plurality of living unit IDs, third-first ID mapping engine 454 may perform operations similar to those described above with respect to FIGS. 5A and 5B to determine a one-to-one visitor tracking cookie-living unit ID mapping at any point in time during the temporal interval.

Similar to fourth-third ID mapping engine 432, fifth-third ID mapping engine 442 includes a mobile device cookie-customer ID module 444 that similarly determines, for each of a plurality of mobile device cookies, a number of customer IDs that each mobile device cookie is mapped to over a temporal interval of customer activity. For example, mobile device cookie-customer ID module 444 may determine whether a mobile device cookie is mapped to one customer ID (e.g., 1:1 mapping 446) or to multiple customer IDs (e.g., 1:2+ mapping 448). If there is only one mobile device cookie and one customer ID (e.g., 1:1 mapping 446), the mobile device cookie is mapped to the one customer ID during the temporal period of customer activity. If, however, there are multiple customer IDs that may be mapped to the mobile device cookie during the temporal period (e.g., 1:2+ mapping 448), mobile device cookie-customer ID module 444 may perform operations similar to those described above with respect to FIGS. 5A and 5B to determine a one-to-one mobile device cookie-customer ID mapping at any point in time during the temporal interval. Fifth-third ID mapping engine 442 generates fifth-third mapped IDs 458 characterizing the 1:1 mobile device cookie-customer ID mapping over the temporal period.

Fifth-first ID mapping engine 456 may receive, for the temporal period, fifth-third mapped IDs 458 from fifth-third ID mapping engine 442, and receive the customer ID-living unit ID mapping from third-first ID mapping engine 454. Fifth-first ID mapping engine 456 may perform operations to generate a mobile device cookie-living unit ID mapping based on the received fifth-third mapped IDs 458 and customer ID-living unit ID mapping. For example, assuming fifth-first ID mapping engine 456 receives a 1:1 mobile device cookie-customer ID mapping and a 1:1 customer ID-living unit ID mapping for the temporal period, fifth-first ID mapping engine 456 maps the one mobile device cookie to the one living unit ID during the temporal period. In some examples, to map a mobile device cookie to one of a plurality of living unit IDs, fifth-first ID mapping engine 456 may perform operations similar to those described above with respect to FIGS. 5A and 5B to determine a one-to-one mobile device cookie-living unit ID mapping at any point in time during the temporal interval.

FIG. 8 is a flowchart of an example method 800 that can be carried out by the customer data mapping system 100 of FIG. 1. Beginning at step 802, a computing device, such as data mapping computing device 102, receives input data identifying a first identifier of a first identifier type (e.g., individual ID) and a plurality of second identifiers of a second identifier type (e.g., customer IDs). At step 804, the computing device obtains, from a database (e.g., database 116), online session data (e.g., online session data 358) and online sales data (e.g., online sales data 356) corresponding to the first identifier and each of the second identifiers.

Proceeding to step 806, the computing device determines, for each of the plurality of second identifiers of the second identifier type, a corresponding session confidence score based on the online session data. Further, and at step 808, the computing device determines, for each of the plurality of second identifiers of the second identifier type, a corresponding sales confidence score based on the online sales data. At step 810, the computing device determines, for each of the plurality of second identifiers of the second identifier type, a corresponding active period score based on the online session data and the online sales data. Further, and at step 812, the computing device determines, for each of the plurality of second identifiers of the second identifier type, a corresponding recent activity score based on the online session data and the online sales data.

Proceeding to step 814, the computing device determines, for each of the plurality of second identifiers of the second identifier type, a final score based on each second identifier's corresponding session confidence score, sales confidence score, active period score, and recent activity score. At step 816, the computing device generates mapping data (e.g., ID mapping data 390) that maps the first identifier to one of the second identifiers based on the final scores of the second identifiers. Further, and at step 818, the computing device stores the mapping data within a database, such as within database 116. The method then ends.

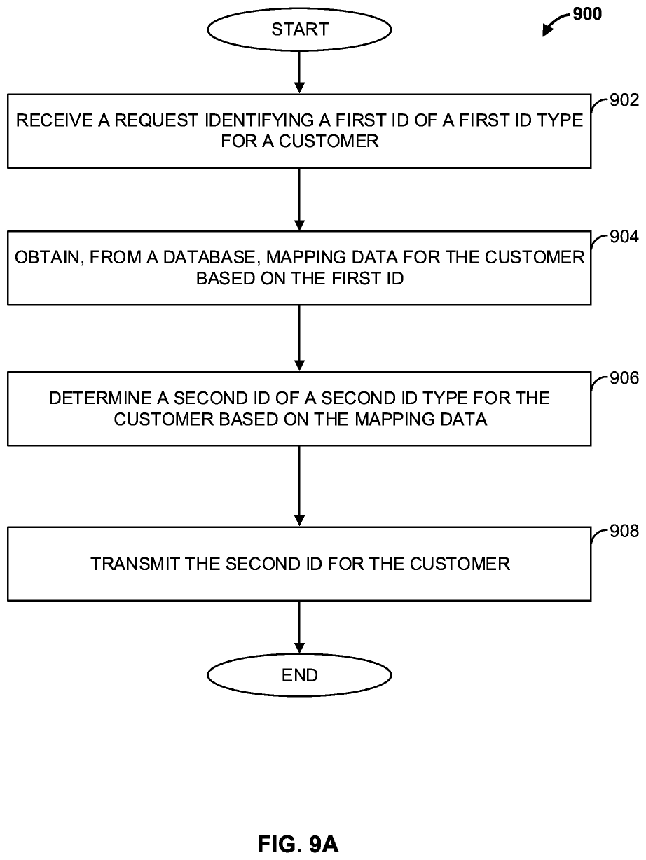

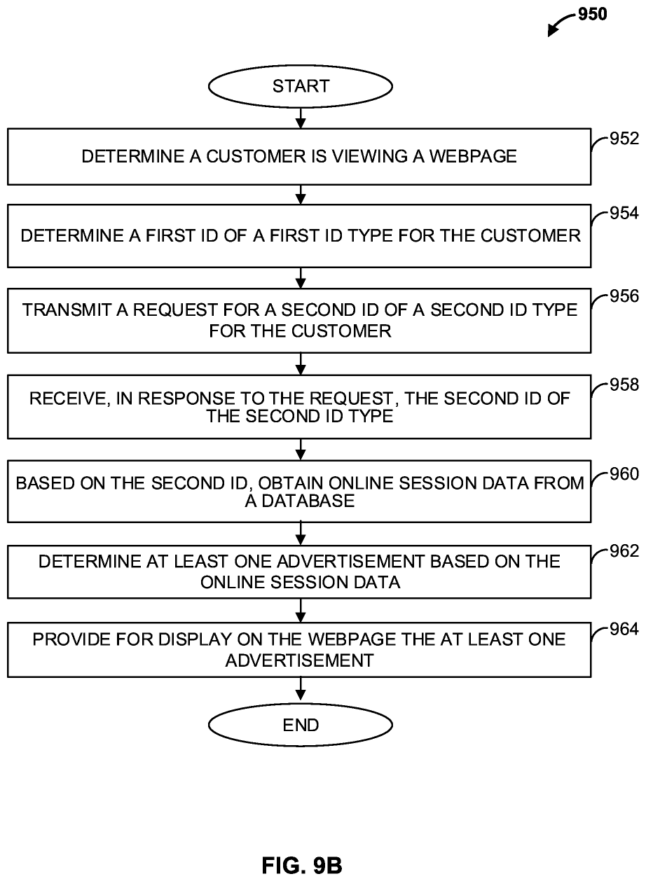

FIG. 9A is a flowchart of an example method 900 that can be carried out by the customer data mapping system 100 of FIG. 1. Beginning at step 902, a computing device, such as data mapping computing device 102, receives a request identifying a first identifier of a first identifier type (e.g., visitor tracking cookie) for a customer. For example, data mapping computing device 102 may receive the request from web server 104 for a customer browsing a website hosted by web server 104. At step 904, the computing device obtains, from a database (e.g., database 116), mapping data (e.g., ID mapping data 390) for the customer based on the first identifier. Further, and at step 906, the computing device determines a second identifier of a second identifier type (e.g., customer ID) for the customer based on the mapping data. At step 908, the computing device transmits the second identifier for the customer. For example, data mapping computing device 102 may transmit the second identifier for the customer to web server 104. The method then ends.

In some examples, the received request further identifies a search query. Data mapping computing device 102 may obtain from a database (e.g., database 116) customer data, such as customer data 350, for the customer based on the mapping data for the customer. Data mapping computing device 102 may further apply a trained machine learning process to the obtained customer data and the search query to generate search results for the customer, and may transmit the search results to web server 104. Web server 104 may receive the search results, and may display the search results to the customer on the website.

In some examples, data mapping computing device 102 obtains from a database (e.g., database 116) customer data, such as customer data 350, for the customer based on the mapping data for the customer. Data mapping computing device 102 may further apply a trained machine learning process to the obtained customer data to generate item advertisements for the customer, and may transmit the item advertisements to web server 104. Web server 104 may receive the item advertisements, and may display the item advertisements to the customer on the website.

FIG. 9B is a flowchart of an example method 950 that can be carried out by the customer data mapping system 100 of FIG. 1. Beginning at step 952, a computing device, such as web server 104, determines a customer is viewing a webpage. For example, web server 104 may host a website, and a customer, via a customer computing device 110, 112, 114, may access the website. At step 954, the computing device determines a first identifier of a first identifier type for the customer. For example, web server 104 may identify an identifier for the customer, such as a visitor tracking cookie or mobile device cookie stored within the customer computing device 110, 112, 114. Alternately, the customer may log into the website using credentials, such as a user name and password. Based on the successful authentication, web server may identify a customer ID for the customer.

Proceeding to step 956, the computing device may transmit a request for a second identifier of a second identifier type for the customer. For example, and in the example that the first identifier is either a visitor tracking cookie or a mobile device cookie, web server 104 may transmit a request for an customer ID to data mapping computing device 102. Alternatively, and in the example that the first identifier is a customer ID, the web server 104 may transmit a request for an individual ID to data mapping computing device 102.

Further, and at step 958, the computing device receives, in response to the request, the second identifier of the second identifier type for the customer. For example, data mapping computing device 102 may determine the second identifier for the customer in accordance with the method of FIG. 9A. At step 960, and based on the second identifier, the computing device obtains online session data from a database. For example, web server 104 may obtain online session data 358 for the customer from database 116.

Proceeding to step 962, the computing device determines at least one advertisement based on the online session data. For example, web server 104 may apply one or more trained machine learning processes to the obtained online session data to determine the at least one advertisement. At step 964, the computing device provides for display the at least one advertisement (e.g., on the webpage). The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

1. A system comprising:
a database; and
a computing device communicatively coupled to the database and configured to:
receive a first identifier of a first type, and a plurality of second identifiers of a second type;
determine customer data associated with each of the plurality of second identifiers of the second type;
generate a confidence score for each of the plurality of second identifiers based on each second identifier's corresponding customer data;
determine that the confidence score is beyond a threshold;
in response to determining that the confidence score is beyond the threshold, generate mapping data that maps the first identifier to one of the plurality of second identifiers based on the confidence scores; and
store the mapping data within the database.

2. The system of claim 1, wherein generating the confidence score further comprises:
generating a session confidence score based on corresponding customer data characterizing session data;
generating a sales confidence score based on corresponding customer data characterizing sales data; and
generating the confidence score based on the session confidence score and the sales confidence score.

3. The system of claim 2, wherein generating the confidence score further comprises:
determining, based on the customer data, a length of time from when activity associated with each of the plurality of second identifiers was first captured to when activity associated with each of the plurality of second identifiers was last captured;
generating an active period score based on the length of time; and
generating the confidence score based on the active period score.

4. The system of claim 2, wherein generating the confidence score further comprises:
determining, based on the customer data, a length of time since activity associated with each of the plurality of second identifiers was last captured;
generating a recent activity score based on the length of time; and
generating the confidence score based on the recent activity score.

5. The system of claim 2, wherein generating the confidence score further comprises:
applying a first weight to the session confidence score;
applying a second weight to the sales confidence score; and
generating the confidence score based on the weighted session confidence score and the weighted sales confidence score.

6. The system of claim 1, wherein the computing device is further configured to determine a temporal interval of the customer data associated with each of the plurality of second identifiers of the second type, wherein the mapping data is generated based on the temporal intervals.

7. The system of claim 6, wherein the plurality of second identifiers comprises a first value and a second value, wherein the computing device is further configured to determine that a temporal interval of the first value ends before a temporal interval of the second value.

8. The system of claim 6, wherein the plurality of second identifiers comprises a first value and a second value, wherein the computing device is further configured to determine that a temporal interval of the first value includes a temporal interval of the second value.

9. A method by a computing device comprising:
receiving a first identifier of a first type, and a plurality of second identifiers of a second type;
determining customer data associated with each of the plurality of second identifiers of the second type;
generating a confidence score for each of the plurality of second identifiers based on each second identifier's corresponding customer data;
determining that the confidence score is beyond a threshold;
in response to determining that the confidence score is beyond the threshold, generating mapping data that maps the first identifier to one of the plurality of second identifiers based on the confidence scores; and
storing the mapping data within a database.

10. The method of claim 9 further comprising:
generating a session confidence score based on corresponding customer data characterizing session data;
generating a sales confidence score based on corresponding customer data characterizing sales data; and
generating the confidence score based on the session confidence score and the sales confidence score.

11. The method of claim 10 further comprising:
determining, based on the customer data, a length of time from when activity associated with each of the plurality of second identifiers was first captured to when activity associated with each of the plurality of second identifiers was last captured;
generating an active period score based on the length of time; and
generating the confidence score based on the active period score.

12. The method of claim 10 further comprising:
determining, based on the customer data, a length of time since activity associated with each of the plurality of second identifiers was last captured;
generating a recent activity score based on the length of time; and
generating the confidence score based on the recent activity score.

13. The method of claim 10 further comprising:
applying a first weight to the session confidence score;
applying a second weight to the sales confidence score; and
generating the confidence score based on the weighted session confidence score and the weighted sales confidence score.

14. The method of claim 10 further comprising determine a temporal interval of the customer data associated with each of the plurality of second identifiers of the second type, wherein the mapping data is generated based on the temporal intervals.

15. The method of claim 14 wherein the plurality of second identifiers comprises a first value and a second value, the method further comprising determining that a temporal interval of the first value ends before a temporal interval of the second value.

16. The method of claim 14 wherein the plurality of second identifiers comprises a first value and a second value, the method further comprising determining that a temporal interval of the first value includes a temporal interval of the second value.

17. A non-transitory computer readable medium having instructions stored thereon, wherein the instructions, when executed by at least one processor, cause a device to perform operations comprising:
receiving a first identifier of a first type, and a plurality of second identifiers of a second type;
determining customer data associated with each of the plurality of second identifiers of the second type;
generating a confidence score for each of the plurality of second identifiers based on each second identifier's corresponding customer data;
determining that the confidence score is beyond a threshold;
in response to determining that the confidence score is beyond the threshold, generating mapping data that maps the first identifier to one of the plurality of second identifiers based on the confidence scores; and
storing the mapping data within a database.

18. The non-transitory computer readable medium of claim 17, further comprising instructions stored thereon that, when executed by the at least one processor, further cause the device to perform operations comprising:
generating a session confidence score based on corresponding customer data characterizing session data;
generating a sales confidence score based on corresponding customer data characterizing sales data; and
generating the confidence score based on the session confidence score and the sales confidence score.

19. The non-transitory computer readable medium of claim 17, further comprising instructions stored thereon that, when executed by the at least one processor, further cause the device to perform operations comprising:
determining, based on the customer data, a length of time from when activity associated with each of the plurality of second identifiers was first captured to when activity associated with each of the plurality of second identifiers was last captured;
generating an active period score based on the length of time; and
generating the confidence score based on the active period score.

20. The non-transitory computer readable medium of claim 17, further comprising instructions stored thereon that, when executed by the at least one processor, further cause the device to perform operations comprising:
determining, based on the customer data, a length of time from when activity associated with each of the plurality of second identifiers was first captured to when activity associated with each of the plurality of second identifiers was last captured;
generating an active period score based on the length of time; and
generating the confidence score based on the active period score.
